(19) United States
(12) Patent Application Publication
(10) Pub. No.: US 2011/0281493 A1
(43) Pub. Date: Nov. 17, 2011

(54) ELECTRONIC WILDLIFE CALL

(76) Inventors: Christopher B. Barley, Grand Prairie, TX (US); James Brandon Roach, Grand Prairie, TX (US)

(21) Appl. No.: 12/777,909

(22) Filed: May 11, 2010

(51) Int. Cl. A01M 31/00

(52) U.S. Cl. 446/397; 446/484

(57) ABSTRACT

An electronic wildlife call has a housing and electronics. The housing has a main body and a pistol type handle extending from the main body. The electronics includes memory with a library of electronic sound calls, a sound generator, a speaker and a user interface. The user interface is at a rear end of the main body and the speaker is at a front end. A pistol-style trigger adjacent the handle sounds the selected call when pulled. The calls are stored according to animal type, with each animal having plural calls. A user can scroll through the calls by animal type. The main body has front and rear portions that are rotatably coupled together. An electrical coupling between the two portions has concentric rings in one portion and pins in the other portion, which pins are in contact with the rings.

### FIELD OF THE INVENTION

The present invention relates to electronic wildlife or animal calls of the type that produce sounds emulating that of wildlife.

### BACKGROUND OF THE INVENTION

Wildlife or animal calls have been in use for a long time, particularly by hunters. A hunter or operator uses the call to make sounds like an animal makes. For example, to attract deer, a hunter may produce sounds that emulate a buck or a doe. To attract coyotes, or other predators, a hunter may produce sounds that emulate a rabbit in distress. To attract ducks, a hunter may use a duck call.

Traditionally, wildlife calls have been manually generated, such as by blowing one's breath across a reed or vibrating membrane or by scratching a plate surface or vibrating a box. Such calls take experience to operate successfully and are limited to making only a small number of specific sounds, say for ducks or turkey.

Recently, electronic calls have come into use. In an electronic call, a number of unrelated animal calls can be stored in memory as sound files and reproduced. Little skill is required to operate an electronic call.

While little skill may be required for operation, nonetheless, prior art electronic game calls require some effort and skill on the part of the user to select the call and operate the device. It is desired to simplify the use of an electronic call.

### SUMMARY OF THE INVENTION

The present invention provides an electronic wildlife call that comprises electronics. The electronics comprises an electronic sound generator, a memory containing at least one sound call, with the memory being connected to the sound generator. A speaker connected with the sound generator through an electrical coupling. A user operated trigger is connected to the electronics and is for controlling when the electronics produces a sound call. A housing containing the electronics. The coupling comprises concentric conductive rings and pins, the pins are aligned to make contact with the rings.

In accordance with one aspect, the housing comprises a first portion containing the speaker and a second portion containing the sound generator. The rings are located in one of the first or second portions and the pins are located in the other of the first or second portions.

In accordance with another aspect, the first portion is rotatably coupled to the second portion.

In accordance with still another aspect, a power supply is in the housing. The power supply is accessible when the first and second portions are uncoupled.

In accordance with still another aspect, a user interface is located on the housing second portion.

There is also provided an electronic wildlife call that comprises electronics, a housing, and a handle. The electronics comprises an electronic sound generator and memory containing at least one sound call. The memory connected to the sound generator. A speaker is connected with the sound generator. The housing contains the sound generator, the memory and the speaker. The handle extends from the housing. A pistol-style trigger is adjacent to the handle and coupled to the electronics, wherein actuating the trigger causes a sound call to be produced from the speaker.

In accordance with one aspect, the handle comprises a pistol type grip.

In accordance with still another aspect, a display and input keys connected to the electronics.

In accordance with still another aspect, the housing comprises a first end and a second end. The speaker is located in the first end, the display and keys are located in the second end.

In accordance with still another aspect, the handle is angled with respect to the housing so that the handle extends below and beyond the housing second end.

A method of operating an electronic wildlife call comprises the steps of providing a library of electronic sound calls. The library comprises folders, with each folder comprising at least one file. Each file corresponds to an electronic sound call. The library has the folders arranged in a folder order. The library has the files in each folder that has plural files arranged in a file order. A display is provided. The display shows at least one of the folders and at least one of the files in the displayed folder. A selection command is received to select between folders or files. A scroll command is received to scroll among either the list of folders if folders are selected or the list of files if files for a selected folder are selected.

In accordance with one aspect, the step of providing a library further comprises the step of providing the folders according to animal types.

In accordance with still another aspect, the step of providing a library further comprises the step of providing the files according to types of sound calls.

In accordance with a further aspect, there is a step of sounding the selected sound call.

### BRIEF DESCRIPTION OF THE DRAWINGS

FIG. 1 is a perspective view of the front end of a wildlife call unit, in accordance with a preferred embodiment.

FIG. 2 is a perspective view of the rear end of the wildlife call unit.

FIG. 3 is a block diagram of the call unit.

FIG. 4 is a flow chart illustrating the primary program of the call unit operation.

FIG. 5 is a flow chart illustrating the key processing program.

FIG. 6 is a perspective view of the call unit, with the housing front portion removed from the housing main body.

### DESCRIPTION OF THE PREFERRED EMBODIMENT

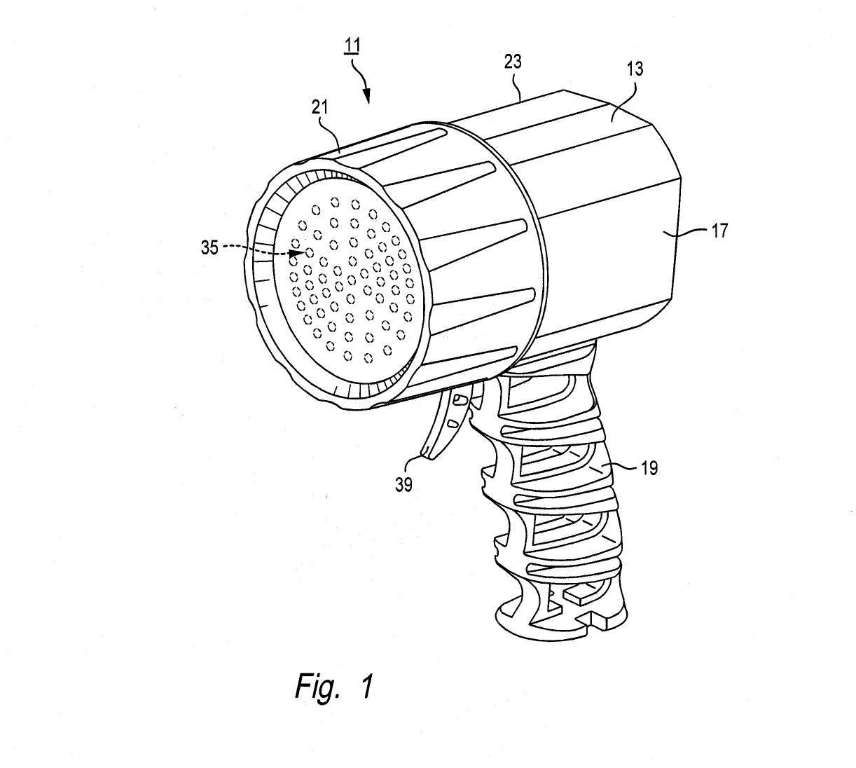

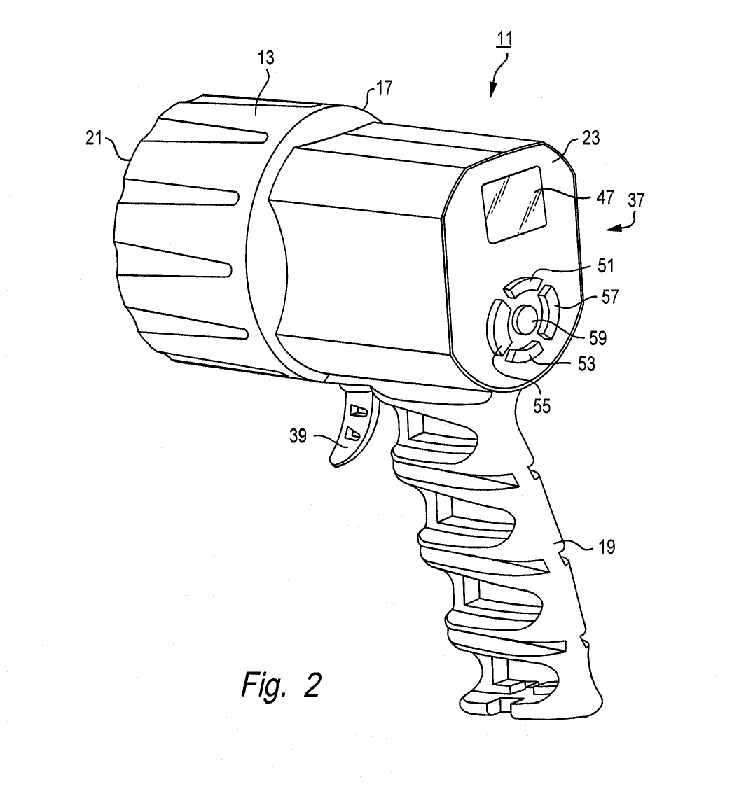

FIGS. 1 and 2 show perspective views of the preferred embodiment of the electronic wildlife call unit 11. The call unit can be used by hunters, wildlife enthusiasts, etc. The call unit contains an internal library of plural sound calls for different animals. For example, the call unit may contain sound calls for birds, hogs, deer, rabbits, squirrels, coyotes, etc. Each animal may have plural sound calls. For example, there may be the following types of deer sound calls: doe bleat, buck grunt, buck bleat and buck snort. As another example, a call unit may have the following type of bird sound calls: blue jay, bobwhite quail, catbird, pileated woodpecker, crow, owl hoot, etc.

The call unit is easy to use. It has a user interface that allows a user or operator to select the desired sound call from the sound call library. Once the sound call is selected, a user activates a trigger to produce the sound call. The call unit is easy for a user to hold and operate with one hand.

The call unit 11 is in general configured much like a pistol. The forward end, which is pointed in the direction the sound is to be directed, contains a speaker 35. The rear end, facing the user, contains the user interface 37. The speaker and user interface are in a main body 17. A handle 19 extends from the main body. The trigger 39 is adjacent to the handle. Thus, the call unit presents a physical configuration analogous to a handgun or pistol, which configuration is familiar to many outdoorsmen and women.

The call unit 11 contains a power supply, which in the preferred embodiment are batteries. The batteries are easily accessed and replaced.

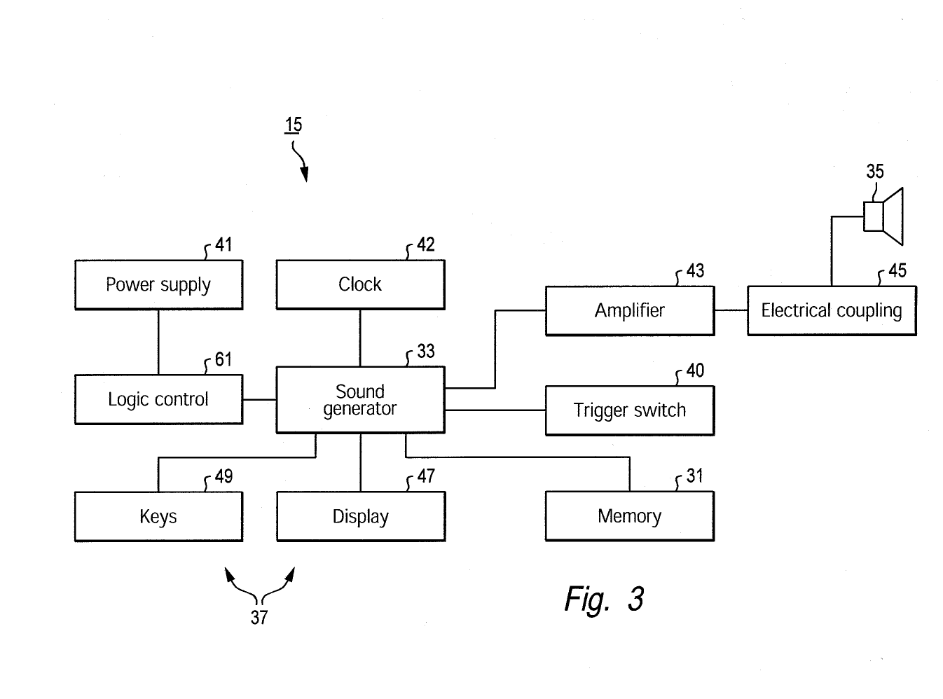

The call unit will now be described in more detail. The call unit includes a housing 13 and electronics 15 (see FIG. 3).

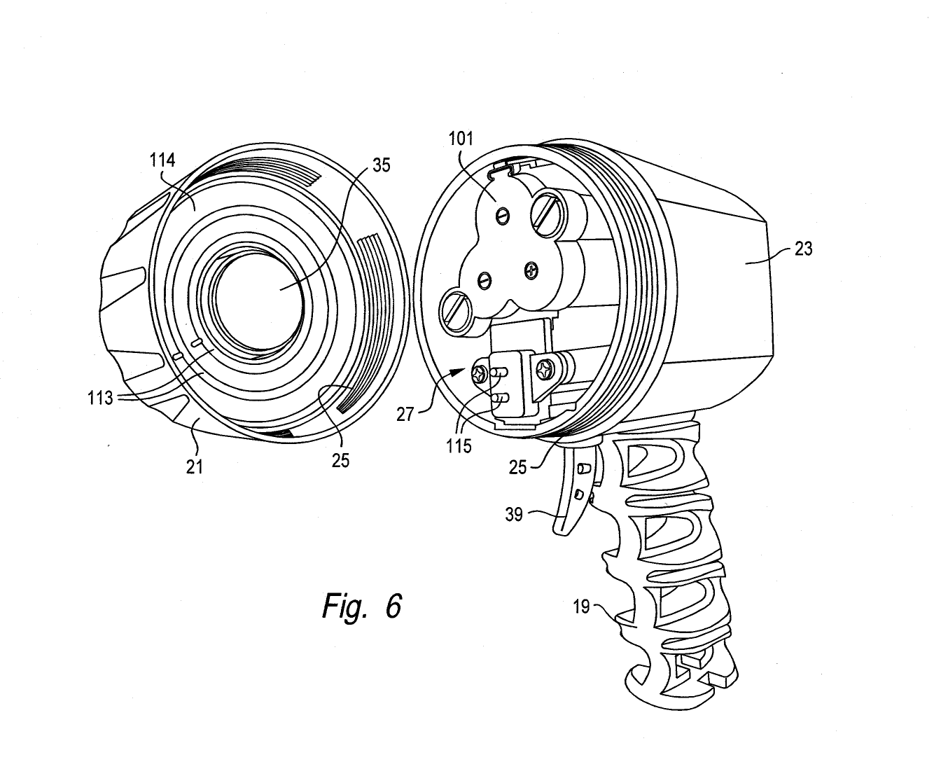

The housing 13 has the main body 17 and the handle 19. The main body 17 has a front portion 21 and a rear portion 23. The front and rear portions 21, 23 are releasably coupled by threads 25 (see FIG. 6). Uncoupling the two portions allows access to a cavity 27 inside that contains the electronics 15. An O-ring (not shown) is provided between the front and rear portions 21, 23 to keep moisture from entering the cavity The handle 19 extends from the main body 17, preferably at an angle. In the preferred embodiment, the handle 19 extends from the rear portion 23 of the main body 17. The handle 19 is of a pistol type in that it extends from the main body at an angle and can be gripped by a human hand. The shape and surface contours of the handle is unique and unlike pistol handles or grips. Nevertheless, a user can grip the handle in a manner similar to a pistol grip.

Referring to FIG. 3, the electronics 15 includes a memory 31, a sound generator 33, a speaker 35, a user interface 37, a trigger switch 40 and a power supply 41.

The memory 31 is nonvolatile computer memory, capable of holding sound files. In the preferred embodiment, the memory 31 is of the flash type and is provided on a memory card. The memory 31 contains the library of sound calls. The memory 31 is connected to the sound generator 33. The memory card may be either permanently installed, or may be replaceable in order to change out the library of calls.

The sound generator 33, or sound processor, is conventional and commercially available. The sound generator 33 has a clock 42. The sound generator 33 takes a sound file from the memory 31, decodes it and provides the resulting data stream to a digital-to-analog converter. The digital-to-analog converter may be integrated into the sound generator or it may be a separate device. In the preferred embodiment, the sound generator is an MP3 decoder, wherein the sound files are stored in memory in the MP3 (MPEG1 Audio Layer 3) format, which is a compressed digital format. The output of the sound generator and the digital-to-analog converter, is an analog audio signal. The audio signals are output to an amplifier 43, which in turn drives the speaker 35. The speaker of course produces the sound. The amplifier 43 is connected to the speaker by way of an electrical coupling 45, which will be described in more detail below. Thus, the speaker is connected with the sound generator.

The user interface 37 is connected to the sound generator 33 and includes a display 47 and keys 49. The display 47 provides information to the user such as the type of sound call, the volume level and the level of battery charge. In the preferred embodiment, the display is a liquid crystal display (LCD). The keys 49 allow a user to select the desired call and adjust the volume. In the preferred embodiment (see FIG. 2), the keys are laid out with an upper key 51, a lower key 53, a left key 55, a right key 57 and a center key 59. The keys have printing (not shown) to indicate their respective function. The upper and lower keys 51, 53 control the volume of sound produced by the speaker. The upper key 51 increases the volume, while the lower key 53 decreases the volume. The left, right and center keys 55, 57, 59 are used to select the particular call that is to be sounded. The display 47 lists the selection of the calls available from the library calls in the general format:

### Animal

### Call

where the animal is in general the particular animal and the call is the particular call for that animal, as the animals can have plural calls.

Before describing the calls and call selection, the remainder of the electronic components will be described.

The power supply 41 is, in the preferred embodiment, batteries. The batteries can be rechargeable, or nonrechargeable. In the preferred embodiment, the batteries are nonrechargeable and must be replaced after being drawn down electrically. The use of nonrechargeable batteries does not require a charging port and allows a call unit to be relatively water resistant. Control logic 61 is provided to regulate the electrical power from the power supply to the remaining electronics.

The trigger 39 activates a trigger switch 40, which is connected to the sound generator.

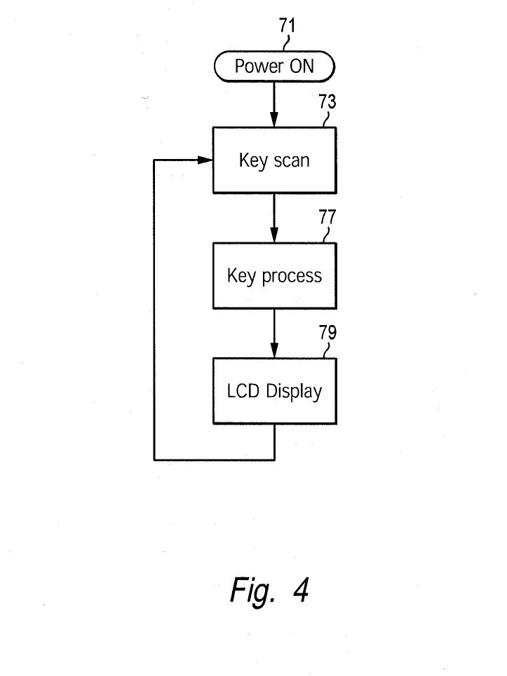

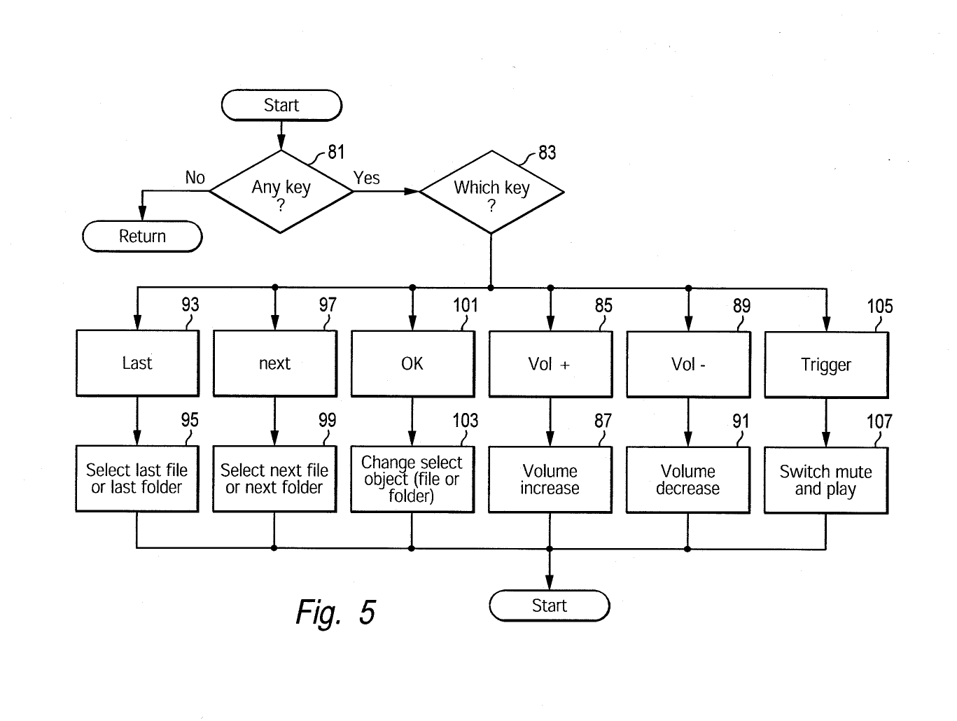

The selection of a particular call will now be described, with reference to FIGS. 4 and 5. FIG. 4 shows a flow chart for the main program, while FIG. 5 illustrates a key processing program. The processes of FIGS. 4 and 5 are implemented by software that is operated by the sound generator.

The call unit is turned on by pressing the appropriate key, step 71. In the preferred embodiment, pressing and holding the center key 59 for a predetermined period of time turns on the display and powers the electronics. The call unit automatically turns itself off if not used for a predetermined period of time in order to conserve electrical power. Once the unit is turned on, the keys 49 are scanned to determine if they have been pressed, step 73. If a key has been pressed, then a key process program is called, wherein the pressed key is identified and the associated action taken, step 77. Then, the display 47 is updated to reflect any change caused by the pressed key, step 79. For example, if the volume level is increased, then this is indicated on the display. The process then repeats to scan for another pressed key.

FIG. 5 illustrates the key processing program of step 77 in more detail. The program determines if a key has been pressed, step 81. If NO key has been pressed, then the program returns to scan for pressed keys, step 73. Steps 73 and 81 can be combined into a single step or be distinct steps as shown. If YES, a key has been pressed, then the program determines which key was pressed, step 83. If the volume increase key 51 was pressed, then this is identified, step 85 and the volume is increased in an incremental amount, step 87. Likewise, if the volume decrease key 53 was pressed, this is identified, step 89 and the volume is decreased in an incremental amount, step 91. As the volume is increased or decreased, the display 47 is updated to show the change (step 79 of FIG. 4). This is done by updating the visual volume indicator on the display.

If the left key 55, or “last” key is pressed, then this is detected, step 93 (FIG. 5) and the last file or folder is selected, step 95. Likewise, if the right key 57, or “next” key is pressed, this is detected, step 97 and the next file or folder is selected, step 99. If the center key 59 is pressed, then this is detected, step 101 and the selected object, which is either a file or folder, is changed to reflect the newly designated object, step 103. The center key 59 acts as a toggle switch to change from file to folder and back to file. When pressed once, the selected object changes to, for example, file, when the center key is pressed again the selected object changes to folder, when the center key is pressed again, the selected object changes to file, and so on. The selected object is what is used to produce a sound call.

If the user squeezes the trigger 39, this is detected, step 105 and the sound generator 33 switches between mute and play, step 107. When the sound generator is on mute, no sound call is produced. When the sound generator is on play, a sound call is produced.

The sound calls are located in the library and stored in memory 31. The animals and calls are preferably listed in alphabetical order. Because the display is physically small, only one animal and one call at a time are listed on the display. The sound calls are scrolled on the display. To simplify the scrolling, the sound calls are organized by animals. The animals represent folders, while sound calls for a particular animal represent a file in a folder. An example library is shown in Table 1:

TABLE 1

| Animal (folder) | Call (file) |
|---|---|
| Coyote | coyote bark |
| | coyote female challenge |
| | male communicative |
| | coyote pup distress |
| | coyote pup group howl |
| Hog | Javelina adult distress |
| | Javelina young distress |
| | pig adult distress |
| | pig young distress |
| Rabbit | cottontail distress |
| | jackrabbit distress |
| | pygmy cottontail distress |
| Whitetail Deer | buck fight |
| | buck growl |
| | buck grunt |
| | buck snort wheeze |
| | doe estrus bleat |
| | fawn bawl |

To change the particular call which will be sounded, the user views the call shown in the display 47. As previously discussed, the display shows the type of animal and the particular call for that animal. To change the call, the left key 55 (last) and/or the right key 57 (next) is pressed to scroll from animal to animal and call to call. Scrolling is done from animal to animal and once an animal is selected from sound call to sound call for that selected animal. This eliminates the need to scroll through the entire list or sound calls. Also, the top of the list loops to the bottom and vice versa. For example, using the call library of Table 1, suppose that the display shows:

### Coyote

### Coyote Bark

and the user wishes to change this to Coyote, male communicative. The user presses the right key 57 twice to scroll to Coyote, coyote female challenge and to Coyote, mail communicative. Alternatively, because the top and bottom of the lists loop to each other, the user could press the left key 55 twice to scroll from the bottom of the list of Coyote sound calls to Coyote, Coyote pup distress and to Coyote, mail communicative.

To change to another animal, the user presses the center key 59. The display shows Coyote as flashing to indicate that the left and right keys 55, 57 will change the animal. Pressing the right key scrolls down through the library of Table 1 to Hog. From Coyote, pressing the left key scrolls up through the animal library to Whitetail Deer. Pressing the center key 59 selects the object to be scrolled from the animal (folder) to the sound call (file), so the display now shows:

### Whitetail Deer

### Buck Fight

The user is able to scroll both up and down the library using the keys. Note that the user was able to skip the specific calls listed under Coyote, Hog and Rabbit in order to change from a coyote call to a whitetail deer call. This minimizes the number of key strokes and entries.

When the user scrolls to a new animal, the selected sound call by default is the top listed call for that animal in the library. For example, when the user selects Hog, selects calls, the display shows Javelina adult distress. Of course, the user can scroll through the Hog calls to select the desired call.

The electronics 15 are located inside of the housing cavity 27, with the exception of the keys 49 and the display 47, which are located on the rear portion of the housing, and specifically on the rear panel, above the handle 19. The speaker is located in the front portion 21 of the housing. The front portion is perforated as shown in FIG. 1 in order to allow sound generated by the internal speaker to exit the housing. The batteries can be accessed and changed by uncoupling the housing front portion 21 from the housing rear portion 23, as shown in FIG. 6. The batteries are contained in a battery compartment 101, which is shown with a lid or cover.

No wires extend from the rear portion 23 of the housing to the front portion 21. This makes the call unit more robust as wires may break when the housing is dissembled. The electrical circuit between the electronics in the rear portion 23 to the speaker 35 in the front portion 21 is made by an electrical coupling 45 in the form of electrical contacts. The front portion has concentric conductive rings 113 that surround the base of the speaker. The rings 113 are located on a printed circuit board 114 that surrounds the magnet component of the speaker 35. The rear portion 23 has spring loaded pins 115; the pins are located to make contact with the rings 113 once the front and rear portions 21, 23 are assembled together. The pins 115 are spring loaded in a direction that is parallel to the longitudinal axis of the main body 17. During assembly, the front portion 21 is threaded on to the rear portion 23 and rotated. When finished, the front portion is snug against the O-ring and the rear portion and pins 115 are in contact with the concentric rings 113 completing the electrical circuit to the speaker 35.

The call unit 11 is easy to use. The call selection can be performed with just one hand. The user grips the call unit by the handle 19 and uses the thumb to press the keys 49. Once the desired call has been selected, the user simply points the call unit in the desired direction and squeezes the trigger 39. This action causes the call unit 11 to produce the selected sound call. The sound call is produced until the trigger is squeezed and released wherein the sound call is ceased to be produced. Thus, the user need not continuously press or squeeze the trigger 39 to sound the call.

Although the trigger 39 has been described as a pistol type trigger, the trigger can be of other non-pistol-style configurations. For example, the trigger can be a button, a toggle, a squeeze pad, etc.

The foregoing disclosure and showings made in the drawings are merely illustrative of the principles of this invention and are not to be interpreted in a limiting sense.

1. An electronic wildlife call, comprising:
a) electronics, comprising:
i) an electronic sound generator;
ii) memory containing at least one sound call, the memory connected to the sound generator;
iii) a speaker connected with the sound generator through an electrical coupling;
b) a user operated trigger connected to the electronics for controlling when the electronics produces a sound call;
c) a housing containing the electronics;
d) the coupling comprising concentric conductive rings and pins, the pins aligned to make contact with the rings.

2. The electronic wildlife call of claim 1 wherein the housing comprises a first portion containing the speaker and a second portion containing the sound generator, with the rings located in one of the first or second portions and the pins located in the other of the first or second portions.

3. The electronic wildlife call of claim 2 wherein the first portion is rotatably coupled to the second portion.

4. The electronic wildlife call of claim 2 further comprising a power supply in the housing, the power supply accessible when the first and second portions are uncoupled.

5. The electronic wildlife call of claim 2 further comprising a user interface located on the housing second portion.

6. An electronic wildlife call, comprising:
a) electronics, comprising:
i) an electronic sound generator;
ii) memory containing at least one sound call, the memory connected to the sound generator;
iii) a speaker connected with the sound generator;
b) a housing containing the sound generator, the memory and the speaker;
c) a handle extending from the housing;
d) a pistol-style trigger adjacent to the handle and coupled to the electronics, wherein actuating the trigger causes a sound call to be produced from the speaker.

7. The electronic wildlife call of claim 6 wherein the handle comprises a pistol type grip.

8. The electronic wildlife call of claim 6 further comprising a display and input keys connected to the electronics.

9. The electronic wildlife call of claim 8 wherein the housing comprises a first end and a second end, the speaker located in the first end, the display and keys located in the second end.

10. The electronic wildlife call of claim 9 wherein the handle is angled with respect to the housing so that the handle extends below and beyond the housing second end.

11. A method of operating an electronic wildlife call, comprising the steps of:
a) providing a library of electronic sound calls, the library comprising folders, with each folder comprising at least one file, each file corresponding to an electronic sound call, the library having the folders arranged in a folder order, the library having the files in each folder that has plural files arranged in a file order;
b) providing a display, the display showing at least one of the folders and at least one of the files in the displayed folder;
c) receiving a selection command to select between folders or files;
d) receiving a scroll command to scroll among either the list of folders if folders are selected or the list of files for a selected folder if files for a selected folder are selected.

12. The method of claim 11 wherein the step of providing a library further comprises the step of providing the folders according to animal types.

13. The method of claim 12 wherein the step of providing a library further comprises the step of providing the files according to types of sound calls.

14. The method of claim 13 further comprising the step of sounding the selected sound call.
